(19) United States
(12) Patent Application Publication
(10) Pub. No.: US 2017/0141636 A1
(43) Pub. Date: May 18, 2017

(54) CENTRALLY-DISTRIBUTED CORELESS WINDING

(71) Applicant: SHANGHAI MOONS' ELECTRIC CO., LTD., Shanghai (CN)

(72) Inventors: Wanbing JIN, Shanghai (CN); Binsong TANG, Shanghai (CN); Huifan NIE, Shanghai (CN); Xin HE, Shanghai (CN)

(21) Appl. No.: 15/418,153

(22) Filed: Jan. 27, 2017

Related U.S. Application Data
(63) Continuation of application No. PCT/CN2016/076101, filed on Mar. 11, 2016.

(30) Foreign Application Priority Data
Jul. 14, 2015 (CN) 201510412976.4

(51) Int. Cl. H02K 3/28

(52) U.S. Cl. CPC H02K 3/28

(57) ABSTRACT

The present invention relates to a centrally-distributed coreless winding, comprising staggered conductors, normal conductors and winding taps, wherein the staggered conductors are concentrated in the middle of the winding, the normal conductors are distributed on both sides of the staggered conductors and the winding taps are located at both ends of the normal conductors, the density in the middle portion of the winding is greater than that of the normal conductors. Compared with the prior art, the invention effectively raises the back electromotive force (BEMF) of the coreless motor and further improves the performance of the motor.

### BACKGROUND

Technical Field

The present invention relates to a winding, and more particularly, to a centrally-distributed coreless winding.

Description of Related Art

In the winding process of a conventional coreless motor, generally, conductors 2 are evenly wound around a winding die 1, and winding taps 3 are located onboth ends of a coil, as shown in FIG. 1, thus forming a coreless winding upon hot flatteningand heat rounding. In this arrangement, when the back electromotive force (BEMF) on the conductors is projected to the center line, the vector BEMF near the center line is much larger than the vectors on both sides since the conductors are spatially evenly-distributed within 120°.

When the serial turn number per coil of the coreless winding or the diameter of the coil increases, the conductors of the same layer cannot be wound on the space of one layer, which will inevitably lead to dislocation of the conductors since the length of the winding die is limited, as shown in FIG. 2. Besides, a staggered-layer phenomenon also probably occurs in consideration of the accuracy of the stroke of a winding machine. In FIG. 2, 2-2 are staggered conductors and 2-1 are normal conductors.For the conductors 2-2, the conductors 2-1 and the staggered conductors 2-2 can be distributed at 120° (including but not limited to 120°) by a conventional winding method, but the even distribution of the staggered conductors over the winding cannot make the BEMF generated by the staggered conductors be effectively used, so that the BEMF generated by the conductors located far away from the center line of the winding is smaller than that of the conductors near the center line of the winding.

### SUMMARY

The objective of the present invention is to provide a concentrically-distributed coreless winding which overcomes the drawbacks of the prior art described above.

To achieve the objective, the present invention adopts the following technical solution:

A centrally-distributed coreless winding, characterized in that, comprising staggered conductors, normal conductors and winding taps, wherethe staggered conductors are concentrated in the middle of the winding, the normal conductors are distributed on both sides of the staggered conductors, and the winding taps are located on both ends of the normal conductors.The density in the middle portion of the winding is greater than that of the normal conductors.

The number of the staggered conductors is 1/10 to ½ of normal conductors.

Preferably, the number of the staggered conductors is ¼ of the normal conductors.

The density of conductors of the winding gradually gets smaller from the middle to both sides.

The number of conductors of the staggered conductors is directly proportional to the inner diameter of the coiled winding.

Compared with the prior art, the advantages of the present invention are as below:

1) Based on the BEMF vector diagram of the coreless motor, the method is proposed to increase the density in the middle of the coil by reducing the conductors' density onboth sides of the coil away from the middle of the winding die. By this method, the BEMF of the coreless motor is effectively enhanced and the performance of the motor is further improved, under the premise that the motor's structure and the number of winding turns do not change;

2) the increased number of conductors in the middle of the coil is subject to the size of the coiled winding, so that it prevents other safety risks resulting from an infinite expansion;

3) the method does not require the modification of equipment, so that engineering can easily be achieved by debugging the winding process of a winding machine.

### BRIEF DESCRIPTION OF THE DRAWINGS

FIG. 1 is a winding structure diagram of the conventional coreless motor;

FIG. 2 is a winding structure diagram of the existing staggered conductors;

FIG. 3 is a structural diagram of the present invention.

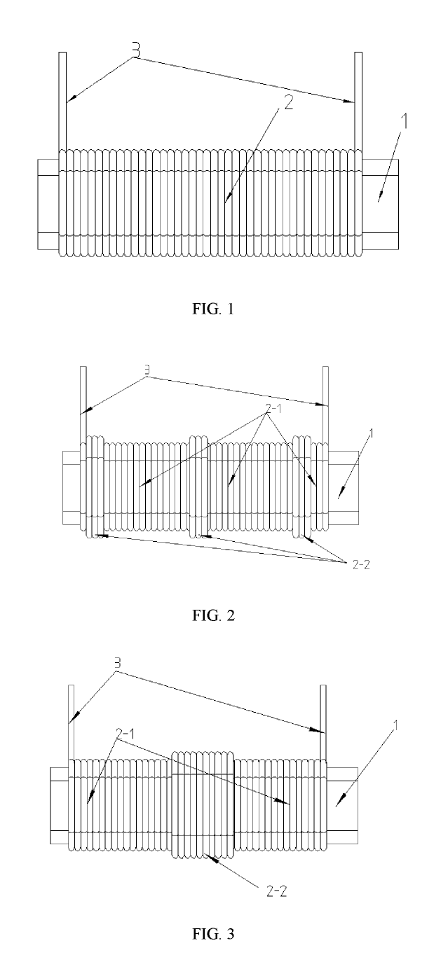

### DETAILED DESCRIPTION

The present invention is further detailed in combination with the drawings and embodiments as follows.

### Embodiments

As shown in FIG. 3, a centrally-distributed coreless winding comprises staggered conductors 2-2, normal conductors 2-1 and winding taps 3, wherein the staggered conductors 2-2 are concentrated in the middle of the winding, the normal conductors 2-1 are distributed on both sides of the staggered conductors 2-2, and the winding taps 3 are located onboth ends of the normal conductors 2-1; the coils' density in the middle portion of the winding where the staggered conductors 2-2 are located is greater than that of the normal conductors 2-1.

The number of the staggered conductors 2-2 is 1/10 to ½ of normal conductors 2-1. Preferably, the number of the staggered conductors 2-2 is ¼ of the normal conductors 2-1.

The density of conductors of the winding gradually gets smaller from the middle to both sides. The number of conductors of the staggered conductors 2-2 is directly proportional to the inner diameter of the coiled winding.

The present invention proposes a solution that conductors could be concentrated near the middle of the coil so that the conductors of the formed coil can be distributed in a sparse-concentrated-sparse state. It is easy to understand from the BEMF vector diagram that the BEMF utilization of these conductors can be enhanced upon concentration of the staggered conductors 2-2 in the middle of the coil. Reducing the density of the coil on both sides while increasing the corresponding number of conductors to the middle of the coil can effectively improve the BEMF of the coreless windingto enhance the motor's electromagnetic performance under the same structure and the same number of turns. However, the increased number of conductors in the middle of the coil is subject to the size of the coiled winding.

What is claimed is:

1. A centrally-distributed coreless winding, comprising staggered conductors, normal conductors and winding taps, wherein the staggered conductors are concentrated in the middle of the winding, the normal conductors are distributed on both sides of the staggered conductors, and the winding taps are located on both ends of the normal conductors; the density in the middle portion of the winding is greater than that of normal conductors.

2. The centrally-distributed coreless winding as claimed in claim 1, characterized in that the number of the staggered conductors that is 1/10 to ½ of the normal conductors.

3. The centrally-distributed coreless winding as claimed in claim 2, characterized in that the number of staggered conductors is preferably ¼ of the normal conductors.

4. The centrally-distributed coreless winding as claimed in claim 1, characterized in that the density of conductors of the winding gradually gets smaller from the middle to both sides.

5. The centrally-distributed coreless winding as claimed in claim 1, characterized in that the number of conductors of the staggered conductors is directly proportional to the inner diameter of the coiled winding.
